(19) United States
(12) Patent Application Publication
(10) Pub. No.: US 2017/0259951 A1
(43) Pub. Date: Sep. 14, 2017

(54) SHAPE MEMORY MEAT PACKAGING

(71) Applicant: Empire Technology Development LLC, Wilmington, DE (US)

(72) Inventor: Michael Keoni Manion, Seattle, WA (US)

(21) Appl. No.: 15/064,388

(22) Filed: Mar. 8, 2016

(51) Int. Cl. B65B 61/24; B65B 25/06; A23B 4/00; B65D 65/02; B65D 75/00; B65B 11/00; B65B 5/02

(52) U.S. Cl. CPC B65B 61/24; B65B 11/004; B65B 25/065; B65B 5/02; B65D 65/02; B65D 75/006; A23B 4/002; A23V 2002/00

(57) ABSTRACT

Techniques and technologies are generally described herein for providing shape memory polymer packaging for meat products from sheets or films of shape memory polymer material. Shape memory polymers are a class of smart materials which have the ability to return to their original or trained state from a deformed or temporary state when a stimulus is provided. The stimulus is typically a temperature change. The stimulus may also be exposure to an electric or magnetic field, exposure to light, or even exposure to a particular atmosphere, e.g., water. Shape memory polymers now include many materials, including both thermoplastic materials and thermoset materials (covalently cross-linked). The memory effect of the shape memory polymer is used to shape a meat product and to make the meat product more attractive to a consumer.

### TECHNICAL FIELD

The technical field of the disclosure relates to food processing and packaging, and in particular to packaging which helps to retain a traditional shape of a cut of meat or other food product.

### BACKGROUND

Many cuts of meat necessarily include connective tissue, which tends to be tougher than is desirable. When these cuts of meat are subjected to mechanical tenderizing, the shape of the cuts may be drastically changed. Cuts of meat may be tenderized using a tenderizing mallet. Cuts of meat may also be tenderized by passing the cuts through a tenderizing machine, in which the meat is subjected to relatively blunt needles or blades as part of the tendering process. These processes may have the effect of flattening out the meat and otherwise changing and distorting the shape of the product. If the change is sufficient enough, the shape of the meat product may no longer have the shape a consumer expects.

In a related problem, when an animal is slaughtered to be used for food, the contraction of muscle fiber causes shortening and toughening of the meat. If there is no restraint on the shape of the meat, which is the case with the hot-boning method, the cooling and contraction of the muscle fibers may result in irregular and unfamiliar shapes of the meat and therefore of the cuts that result when the meat is subsequently packaged for selling or serving.

The foregoing and other relatively uncontrolled processes lead to aesthetic concerns for the meat or other food products. Consumers are less likely to purchase portions of meat or other food products which have unfamiliar shapes. It would be beneficial if there were a method to restore a shape of these products to a shape that is familiar and desirable to potential consumers so that a potential consumer of the product could be positively influenced by the shape and appearance of the product.

Unless otherwise indicated herein, the materials described in this section are not prior art to the claims in this application and are not admitted to be prior art by inclusion in this section.

### SUMMARY

Technologies are herein described for methods and systems for packaging of meat and other food products. The packaging used is made from a shape memory polymer, illustratively in the form of a sheet. The sheet is trained during its manufacture to assume a particular shape by, for example, heat or light. Later, after some cooling below the transition temperature of the material as explained below, the sheet is stretched into a temporary shape that allows for easy storage and shipment, such as a flat sheet. When heated above its transition temperature, it will return to its “memorized” shape.

One embodiment of the disclosure is a method for shaping a food item. The method includes providing a shape memory packaging material; stretching the shape memory packaging material around a mold of a desired shape; programming the shape memory packaging material to take the shape of the mold; and stretching the programmed shape memory packaging material into a temporary shape.

Another embodiment of the disclosure is a method for shaping a food item. The method includes a step of providing a shape memory packaging material configured to transition to a shape of a mold when a transition parameter of the shape memory packaging material is triggered. The method further includes wrapping a food item with the shape memory packaging material and then triggering the transition parameter to cause the shape memory packaging material to take the shape of the mold.

Another embodiment is a package for shaping a food item prepared by a process comprising the steps of: providing a shape memory packaging material configured to transition to a shape of a mold when a transition parameter of the shape memory packaging material is triggered; wrapping a food item with the shape memory packaging material; triggering the transition parameter to cause the shape memory packaging material to take the shape of the mold; and separating the shape memory packaging material from the mold.

The shape memory packaging material may be selected from the group consisting of a polyurethane, a polyurethane with an ionic component, a polyurethane with a mesogenic component, a polyethylene terephthalate block copolymer, a polyethylene oxide copolymer, a block copolymer comprising polystyrene and poly (1,4-butadiene, an ABA triblock copolymer and an ABA triblock copolymer comprising poly-tetrahydrofuran and poly (2-methyl-2-oxazoline).

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE FIGURES

The foregoing and other features of this disclosure will become more fully apparent from the following description and appended claims, taken in conjunction with the accompanying drawings. Understanding that these drawings depict only several embodiments in accordance with the disclosure and are, therefore, not to be considered limiting of its scope, the disclosure will be described with additional specificity and detail through use of the accompanying drawings, in which:

FIGS. 1A-1D depict an illustrative process for manufacturing shape memory packaging from shape memory polymers according to the present disclosure;

FIGS. 2A-2C depict an illustrative process for using the shape memory packaging materials to improve appearance of a food product according to the present disclosure;

FIG. 3 depicts an illustrative food product according to the present disclosure;

FIG. 4 depicts a first illustrative process for forming shape memory packaging from shape memory polymers according to the present disclosure;

FIG. 5 depicts a second illustrative process for forming shape memory packaging from a shape memory polymer packaging material according to the present disclosure;

FIGS. 6A-6D depict illustrative shapes of selected meat products that may be desirable for shapes of the shape memory polymer packaging material according to the present disclosure;

FIG. 7 is a flow chart depicting an illustrative use of shape memory polymer packaging material according to the present disclosure; and

FIG. 8 is a flow chart depicting an illustrative formation of a sheet of shape memory polymer packaging material according to the present disclosure; all of the figures arranged according to at least some embodiments presented herein.

### DETAILED DESCRIPTION

In the following detailed description, reference is made to the accompanying drawings, which form a part hereof. In the drawings, similar symbols typically identify similar components, unless context dictates otherwise. The illustrative embodiments described in the detailed description, drawings, and claims are not meant to be limiting. Other embodiments may be utilized, and other changes may be made, without departing from the spirit or scope of the subject matter presented herein. It will be readily understood that the aspects of the present disclosure, as generally described herein, and illustrated in the Figures, can be arranged, substituted, combined, separated, and designed in a wide variety of different configurations, all of which are explicitly contemplated herein.

Broadly speaking, a method for shaping a food item is disclosed. The method includes providing a shape memory packaging material; stretching the shape memory packaging material around a mold of a desired shape; programming the shape memory packaging material to take the shape of the mold; and then stretching the shape memory packaging material into a temporary shape that lends itself easier to storage, shipping, and use. In another embodiment of the disclosure the method includes a step of providing a shape memory packaging material configured to transition to a shape of a mold when a transition parameter of the shape memory packaging material is triggered. The method further includes wrapping a food item with of shape memory packaging material and then triggering the transition parameter to cause the shape memory packaging material to take the shape of the mold.

Techniques and technologies generally described herein improve the appearance of meat products and other products for display, sale and consumption. Another advantage for the techniques and technologies herein described comes from the packaging used to surround or wrap meat products with suitable protective material. By this disclosure, the packaging process can be used to assist in portion control for meat products and other food products. This can greatly assist in efforts to achieve uniform portions, for example, in catering, where uniform portion sizes are important. This may also assist in dietetic food preparation programs where uniform portion size itself aids consumers by regulating their consumption.

As mentioned above, one problem addressed by the present disclosure is the need to process and tenderize food products, such as meat, which might otherwise not be as palatable as desired. In particular, the more connective tissue there is in a particular cut of meat, the tougher it is. Consumers tend to rate the eating quality, and hence the value, based upon this toughness of the meat. Filet mignon, also known as beef tenderloin, has a desirable shape and needs no tenderizing. The same may be said for the loin cuts of meat known typically as T-bone steak, strip steak, and New York steam. Flank steak, on the other hand, is more desirable for consumers after it has been tenderized.

Meat can be tenderized by a number of means to break down the connective tissue within the muscle fibers to make the eating experience more pleasant. Examples include mechanical disruption, such as a tenderizing machine using co-rotating drums with thin, relatively blunt blades or needles. Cuts of meat may be passed once or more through the tenderizer to break the connective tissue. Pressure and disruption can also be applied by a blunt or faceted tenderizing mallet. These techniques are effective in making the meat more tender, but they tend to leave the cut flatter and misshapen. Such cuts have less “eye appeal” to the consumer. This can also affect the consumer's perception of the value of the cut, since the consumer may attribute a particular shape and appearance to a particular quality of meat.

The problem of appearance also arises from a common technique used in processing fresh meat, a process commonly known as hot-boning. In this process, a carcass is disassembled and packaged prior to the onset of rigor mortis. The various cuts of meat may be shaped differently from chilled meat processed with more traditional approaches. Accordingly, the cuts of meat may not assume the shape customers are accustomed to seeing.

In either of these scenarios, there is a need for a shaping of the final product of meat so that it has a form factor that is more functional and more appealing to a consumer. The shaping adds value, particularly at the point of sale of the final product. Depending on the application, one aspect of shaping the product may be to portray a familiar shape to the consumer, so that the consumer can identify the product with a higher or lower value depending upon the shape that the consumer may expect for a particular cut of meat. For example, a short, right-cylindrical shape with a diameter of 6 cm −8 cm is typically associated with filet mignon. Other shapes may also be associated with high value. Alternatively, another aspect of meat shaping may be to produce products with new and interesting shapes, thus appealing to a segment of customers who value new experiences. As mentioned, above, the shaping of the product may also assist in providing uniformity of portions in both size and shape. This may be very important, for example, in catering applications.

This disclosure provides techniques and technologies for providing shape memory polymer packaging from sheets or films of shape memory polymer (SMP) material. Shape memory polymers are a class of smart materials which have the ability to return to their original or trained state from a deformed or temporary state when a stimulus is provided. SMPs are polymers whose qualities have been altered to give them dynamic shape “memory” properties. The stimulus is typically a temperature change. The stimulus may also be exposure to an electric or magnetic field, exposure to light, or even exposure to a particular atmosphere, e.g., water. Using these stimuli, SMPS can exhibit a radical change from a rigid polymer to a very elastic polymer, then back to a rigid state again. Shape memory polymers now include many materials, including both thermoplastic materials and thermoset materials (covalently cross-linked).

These materials include linear block copolymers, such as polyurethanes with ionic or mesogenic components. Also included are block copolymers such as polyethylene terephthalate (PET) and polyethylene oxide (PEO), block copolymers containing polystyrene and poly (1,4-butadiene). Shape memory polymers also include ABA triblock copolymers made from poly (2-methyl-2-oxazoline) and poly-tetrahydrofuran. Other materials exhibiting a shape memory effect include thermoset polymers such as amorphous polynorbornene. An example is Norsorex, developed by CdF Chemie and Nippon Zeon. There are also organic-inorganic hybrid polymers with polynorbornene units that are partially substituted by polyhedral oligosilsequioxane (POSS).

While most SMP materials tend to be thermosets, some thermoplastic polymers, such as polyetheretherketone (PEEK) may also be used.

Having thus introduced the foregoing overview on shape memory polymer packaging, we now introduce more features that make these products possible, along with descriptions of the processes used in their making. In describing this disclosure more fully, we make reference to the accompanying drawings, in which illustrative embodiments of the present disclosure are shown. This disclosure may, however, be embodied in a variety of different forms and should not be construed as so limited by the drawings.

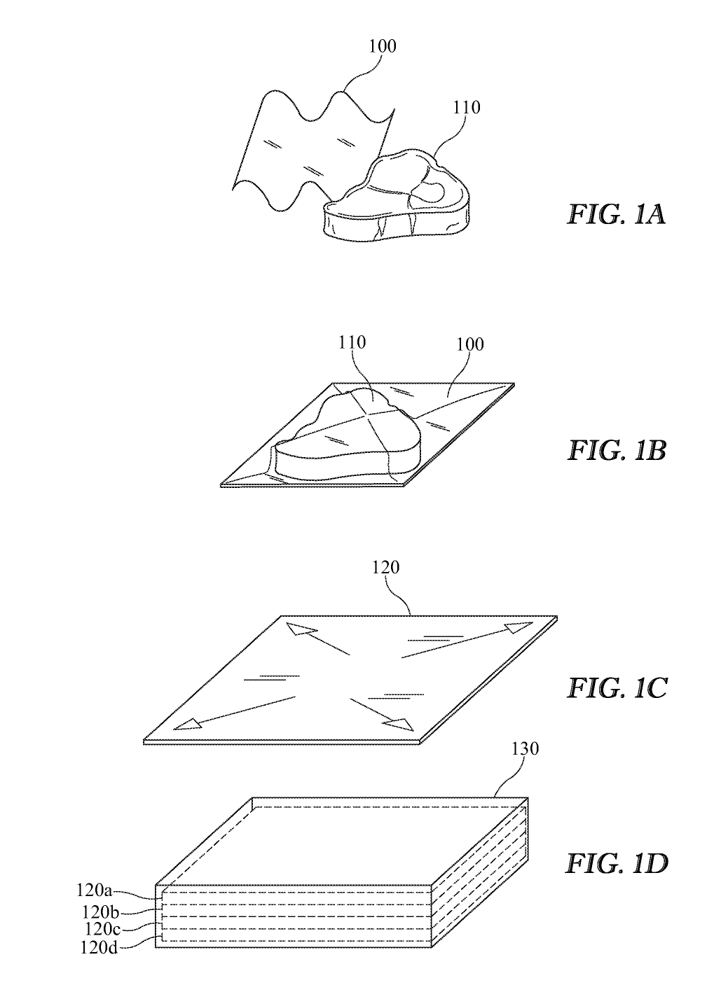

FIGS. 1A-1C depict how shape memory polymer materials are used to manufacture shape memory packaging according to the present disclosure. In FIG. 1A, a sheet of shape memory polymer material 100 is provided, along with a mold 110. The shape memory polymer material is a class of smart materials which have the ability to return to their original or trained state from a deformed or temporary state when a stimulus is provided. The stimulus is typically a temperature change. The stimulus may also be exposure to an electric or magnetic field, exposure to light, or even exposure to a particular atmosphere, e.g., water. Shape memory polymers now include many materials, including both thermoplastic materials and thermoset materials (covalently cross-linked).

These shape memory polymer materials include linear block copolymers, such as polyurethanes with ionic or mesogenic components. Also included are block copolymers such as polyethylene terephthalate (PET) and polyethylene oxide (PEO), block copolymers containing polystyrene and poly (1,4-butadiene). Shape memory polymers also include ABA triblock copolymers made from poly (2-methyl-2-oxazoline) and poly-tetrahydrofuran. Other materials exhibiting a shape memory effect include thermoset polymers such as amorphous polynorbornene. An example is Norsorex, developed by CdF Chemie and Nippon Zeon. There are also organic-inorganic hybrid polymers with polynorbornene units that are partially substituted by polyhedral oligosilsequioxane (POSS).

While most SMP materials tend to be thermosets, some thermoplastic polymers, such as polyetheretherketone (PEEK) may also be used.

The mold is illustratively made from a metal that is stainless steel. Alternatively, the mold may be made from any non-toxic metal or other material that is rigid at temperatures higher than the shaping temperature of the shape memory polymer material. For example, a ceramic or a rigid plastic with a melt temperature higher than the shaping temperature of the shape memory polymer material may be used. The mold may be one sided, or two sided, to provide a three dimensional shape in order to train the shape memory packaging material.

As depicted in FIG. 1B, the mold 110 is in the desired shape of the product, in this case a desirable cut of steak. The sheet of shape memory polymer material 100 is stretched over the mold 110 as depicted in FIG. 1B and is trained to take the desired shape of the mold by heating. Training of the shape memory polymer occurs by manipulation of certain physical properties of the shape memory polymer material.

For example, if the stimulus of shape memory polymer material 100 is a temperature change, the physical property of shape memory polymer material of transition temperature may be used. The temperature required to establish the physical crosslinks for the permanent shape may be greater than the highest transition temperature, Tₚₑᵣₘ. This is a very high temperature that is used to train the shape memory polymer material 100 to remember the shape of the mold. The temperature required to establish the physical crosslinks for the permanent shape is referred to as the shaping temperature in this disclosure.

In FIG. 1B, after the shape memory polymer material 100 is wrapped around the mold, the shape memory polymer material 100 is heated to the shaping temperature to train the shape memory polymer material 100 to remember the shape of the mold after the glass transition temperature is removed. The stimulus may also be exposure to an electric or magnetic field, exposure to light, or even exposure to a particular solvent, e.g., water.

The SMP may be formed with a shaping temperature that matches an application need. An illustrative transition temperature shaping temperature may be from about −30° C. to 260° C. Above its transition temperature, which may be designed to a specific application, the SMP goes from a rigid, plastic state to a flexible, elastic state and at the shaping temperature the SMP is programmed FIG. 1B shows the SMP taking on the shape of the mold due to the heating of the shape polymer material 100 to the shaping temperature.

The shape polymer material 100 will retain the shape of the mold, which is the deformed state, after the shape polymer material 100 is cooled below the transition temperature. Typically, this deformed state is not conducive to storage and shipping since it takes up a lot of space. It also may not make it easy to package the meat since the meat must be forced into the deformed state of the material which may not be easy to do or efficient. For that reason, the deformed shape polymer material 100 is typically stretched after cooling to a temperature below the transition temperature in order to draw the shape polymer material 100 illustratively back into the form factor of a sheet which lends itself to storage and shipping. It also makes it easier to apply to a cut or cuts of meat as explained below. The temperature at which the material is stretched is hereinafter referred to as the stretching temperature.

This “stretching” is shown in FIG. 1C, where a sheet of trained material 120 is shown after being “stretched” after separation from the mold and sufficient cooling to the stretching temperature. In this illustrative embodiment, the trained material 120 is shown stretched into a flat sheet which as previously mentioned lends itself to storage and shipping. As above mentioned, the flat sheet also makes it easy to wrap the flat sheet around a piece or pieces of meat when the trained material 120 is ready to be used as explained below. The sheet is now ready for use with food products such as actual cuts of meat as explained below.

For commercial purposes, several or many sheets of the trained material 120 may be collected and boxed for future use. This is depicted in FIG. 1D wherein a box 130 is shown to contain several sheets of trained material 120—specifically trained material 120a, 120b, 120c, and 120d.

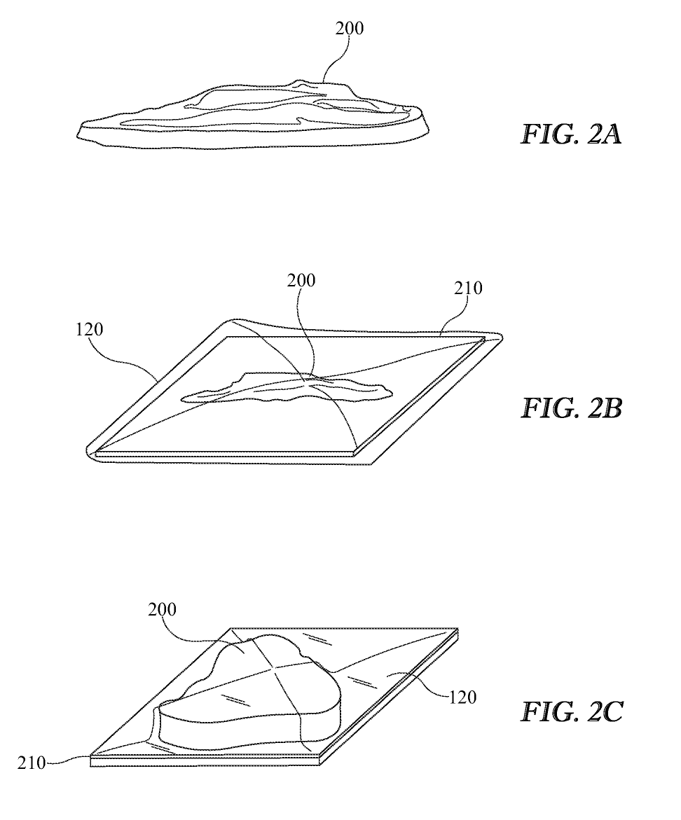

The use of the trained material 120 which has been “trained” to take on a shape as previously described is depicted in FIGS. 2A-2C. A misshapen food item 200, such as a flattened cut of meat, in FIG. 2A, is illustratively placed upon a conventional tray 210 and is wrapped in the sheet of trained material 120, as shown in FIG. 2B. Alternatively, the cut of meat may be wrapped in the sheet of trained material 120 without using the tray 210. Tray 210 may be made of several materials such as polystyrene foam, clear plastic, recycled paper, and molded pulp. Once wrapped, the food item 200 and its packaging material 120, the combination depicted as wrapped food item 220, and heated to glass transition temperature (T_{g}) or a melting temperature (Tₘ) so that the packaging assumes its trained state. The glass transition temperature (T_{g}) and a melting temperature (Tₘ) are also referred to as the trigger temperature in this disclosure. This is shown in FIG. 2C. The trigger temperature, may be in the range of −30° C. to 260° C., and more typically perhaps is in the range of −10° C. to 100° C. Just as the SMP may be formed with a shaping temperature that matches an application need, so too the SMP may be formed with a glass transition temperature (T_{g}) or a melting temperature (Tₘ) that matches an application. More useful temperatures may be in the range of 0° C. to 30° C. In an illustrative example, if the transition temperature is set to between 10° C. and 20° C., then by applying the packaging, the intrinsic temperature of the meat would trigger the shift in the packaging back to the memory shape.

As can be seen from FIGS. 1A, 1B and 1C and FIGS. 2A, 2B and 2C, the shaping temperature and trigger temperature are physical properties of the shape memory polymer material 100. The specific shape memory polymer material 100 used for a particular application may depend upon the shaping temperature and trigger temperature desired for a particular application. For example, a shape memory polymer material 100 having a lower shaping temperature and trigger temperature may be desirable when the process used in this disclosure operates at a low shaping and trigger temperature and a mold is used having a lower melting temperature. If the mold is steel, a shape memory polymer material 100 having a higher shaping temperature and trigger temperature may be used. The particular shaping temperature and trigger temperature used in a particular application is a matter of design choice.

The same is true for any stimulus that is other than a temperature change. For example, the stimulus may also be exposure to an electric or magnetic field, exposure to light, or even exposure to a particular atmosphere, e.g., water. For any of these and other stimuli useable with this disclosure, the selection may depend on the physical properties that are manipulated by that stimulus. The selection of the particular shape memory polymer material 100 is a design choice based upon the particular application.

The above figures demonstrate the basics of both training the shape memory polymer material to take on the shape of a mold about which the shape memory polymer material is placed and triggering the shape memory polymer material to take on the particular shape it has been trained to take once wrapped around a cut of meat or other food item. Specifically, FIGS. 1A-1D, demonstrate the basics of training the shape memory polymer materials. FIGS. 2A-C demonstrate the basics of triggering the shape memory polymer materials that has previously been shaped once the shape memory polymer materials is wrapped around a cut of meat or other food item.

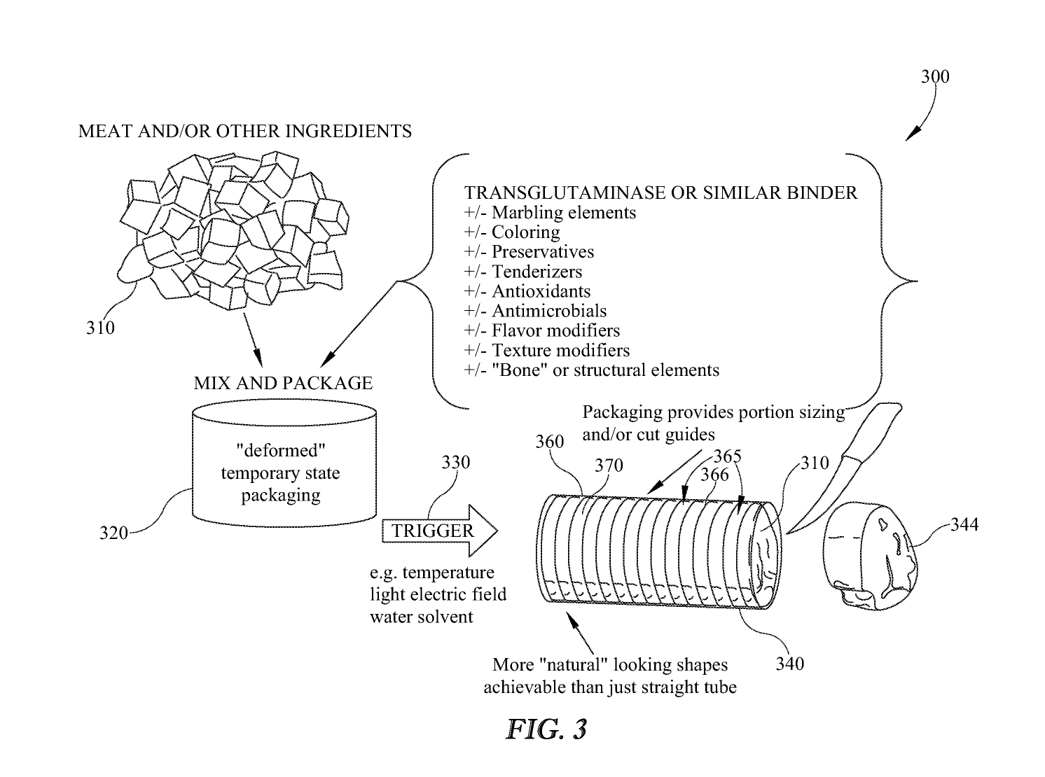

The mold or form used for the process, as well as the shape memory polymer itself, should be suitable for food handling applications. Sanitizing of the mold and all processing equipment should be conducted at regular or prescribed intervals to ensure the safety of the food packing material produced. Stainless steel is typically used in food processing because it is easy to clean and sterilize, without danger of corrosion. Alternatively, another material able to withstand suitable temperatures used for “training” the shape memory polymer sheets, may be used, e.g., ceramic, another metal or rigid plastic with a high melt temperature. The mold can be shaped for the final desired shape, as in FIG. 1A. Alternatively, the mold may be suitable for a larger package, as in FIG. 3, in which a particular shape is intended for a larger portion of meat and or other ingredients that may then cut to smaller sizes for multiple servings. More specifically, FIG. 3 shows meat and/or other ingredients 310 mixed and packaged into a deformed temporary state packaging 320.

Advantageously, packaging 320 is made from a shape memory polymer material configured according to this disclosure. The shape memory polymer materials useable for packaging 320 may include those shape memory polymer materials previously discussed. The shape memory polymer materials of the packaging 320 is then, prior to use, trained to take the desired shape of the mold by heating as previously discussed.

For example, if the stimulus of shape memory polymer material is a temperature change, the physical property of shape memory polymer material of shaping temperature may be used to train the shape memory polymer material to remember the shape of the mold. More specifically, in FIG. 3, the packaging 320 is trained by the shaping temperature to remember the shape taken by element 340. This is done by wrapping packaging 320 around a mold in the shape of element 340 and applying the shaping temperature to configure the packaging 320 with this shape. Subsequent to that training, the packaging 320 is removed from the mold and cooled to a stretching temperature. As noted, the packaging is then illustratively stretched into a temporary state prior to its use in packaging. FIG. 1C depicts a stretched state of a sheet of SMP. In FIG. 3, packaging 320 is depicted as a pouch for receiving the meat and/or other ingredients 310.

Also, and as also previously discussed, while packaging 320 was described to be trained using temperature changes, the stimulus may be other than a temperature change. For example, the stimulus may also be exposure to an electric or magnetic field, exposure to light, or even exposure to a particular environment, e.g., water. In any case, the application of the stimulus or temperature trigger 330 to the packaging 320 will activate the packing to return to the shape in which it was trained.

Referring still to FIG. 3, after the trained but yet to be triggered packaging 320 is filled with meat and/or other ingredients 310, the packaging 320 is triggered at step 330 using the triggering temperature to remember the shape it was trained to remember when it was shaped using the shaping temperature. Again, if the trigger is other than a temperature change, such as an electric field, or water solvent, the applicable trigger would be employed at step 330.

The triggering temperature causes packaging 320 to take on memory shape package 340 which was the programed shape of the packaging 320 when trained by the application of the shaping temperature. The memory shape package 340 advantageously shapes meat and/or other ingredients 310 into the illustrative shape formed by memory package 340 which has many advantages. Portion 344 illustrates a portion that may be cut from meat and/or ingredients 310 after having been so shaped according to this disclosure.

Use of the disclosure as illustrated in FIG. 3 may occur, for example, at catering events or for restaurant applications, where uniform and attractive serving sizes are desired. The disclosure teaches the use of shape memory polymer, or sheets or other configurations of the shape memory polymer material, formed about a mold of a desired shape as a template for the final shape subjected to the shaping temperature to program the shape memory material to remember the final shape when subjected to the trigger temperature. After a sheet of shape memory polymer is formed according to this disclosure, it is removed from the mold and may be stored at ambient or other temperatures for later use so long as the storage temperature is below the trigger temperature.

Illustratively, a plurality of sheets of shape memory polymer formed according to this disclosure may be packaged together into a commercially useful package such as depicted in FIG. 1D for use in shaping a food product at a later point in time. When used, the sheet of shape memory polymer is stretched over the particular desired cut of meat or food. Shape memory polymers can be stretched to as much as 800% of their memory shape. The ability to stretch, and the stiffness or modulus of the sheet, provides the force for shaping the packaging into its memorized shape when it is triggered to do so by application of the trigger temperature. Illustratively, the shape memory polymer may be selected so that the trigger temperature need be applied transiently so as to not affect the core temperature of the meat. In one example and as previously mentioned, if the transition temperature for hot-boned meat is set between 10° C. and 20° C., then by applying the packaging, the intrinsic temperature of the meat would trigger the shift in the packaging back to the memory shape. Normally processed meat would not be packaged until after chilling

In some embodiments, the chemical or photo-crosslinking is used to set the desired shape, depending on the particular type of shape memory polymer used.

Once the meat or other item is packaged in the shape memory polymer packaging, the trigger temperature (or other trigger if a trigger other than temperature is used) to produce the shape memory effect is applied. The trigger used depends on the particular shape memory polymer used. As noted, typically the trigger is applied as a temperature, raising the temperature of the polymer above the transition temperature but below a temperature at which the stability of the polymer is questioned, e.g., the glass transition temperature. The transition temperature may be from −10° C. to +100° C. In a hot boning application, where the meat is processed at room temperature or above room temperature, shape memory polymer with a transition in the range of 10° C. to 20° C. may be used. When the packaging is applied, the meat itself provides the trigger to the desired shape.

An illustrative example of the shape memory polymer packaging is depicted in the diagram 300 of FIG. 3. As explained above, meat and other ingredients 310 may be mixed to form a food product. The meat may be portions or misshaped and smaller cuts of meat. Other components may include a binder, such as transglutaminase, and a variety of ingredients. The ingredients may include marbling elements, coloring, preservatives, tenderizers, antioxidants, antimicrobials, flavor and texture modifiers, and others as desired. The meat and other ingredients 310 are then packaged in a shape memory polymer package 320 preprogrammed to take on the illustrative shape formed by memory package 340 by the application of the shaping temperature. The shape memory polymer package 320 is then triggered to take on the illustrative shape formed by memory package 340 by application of an elevated trigger temperature, such as a cooking temperature of 50° C. to 90° C., or other desired temperature. At that temperature, the shape memory polymer package assumes the shape of memory package 340. In this embodiment, the packaging shape may be generally cylindrical, perhaps with ribs 360, or thicker portions 365, as well as thinner portions 370 of plastic between the ribs. While thicker portions 365 are shown with an intermediate rib 366, the thicker portions 365 may be with or without the rib. Advantageously, small, intermediate, large, or other shapes may be programmed into the shape of the package to facilitate and expedite serving. For example, when a server or a catering staff member wishes to cut individual portions 344, cuts may be made along the ribs, thus ensuring more uniform portions.

The transglutaminase that may be used stems from a newer methodology used in cooking. The so-called molecular gastronomy movement in cuisine calls for the use of agents or binders such as transglutaminase to produce a larger piece of meat, or other food, by adhering together smaller pieces, and optionally other ingredients, as mentioned above. This is achieved, it is believed, through isopeptide bonds. Other emerging processes also provide for the improvement of certain cuts, such as by artificially marbling them, or by blending different fibers or parts together to create portions with a pleasing and high-value appearance. This is an area of growing interest and possible product opportunities, especially for creating a value uplift of commodity food products.

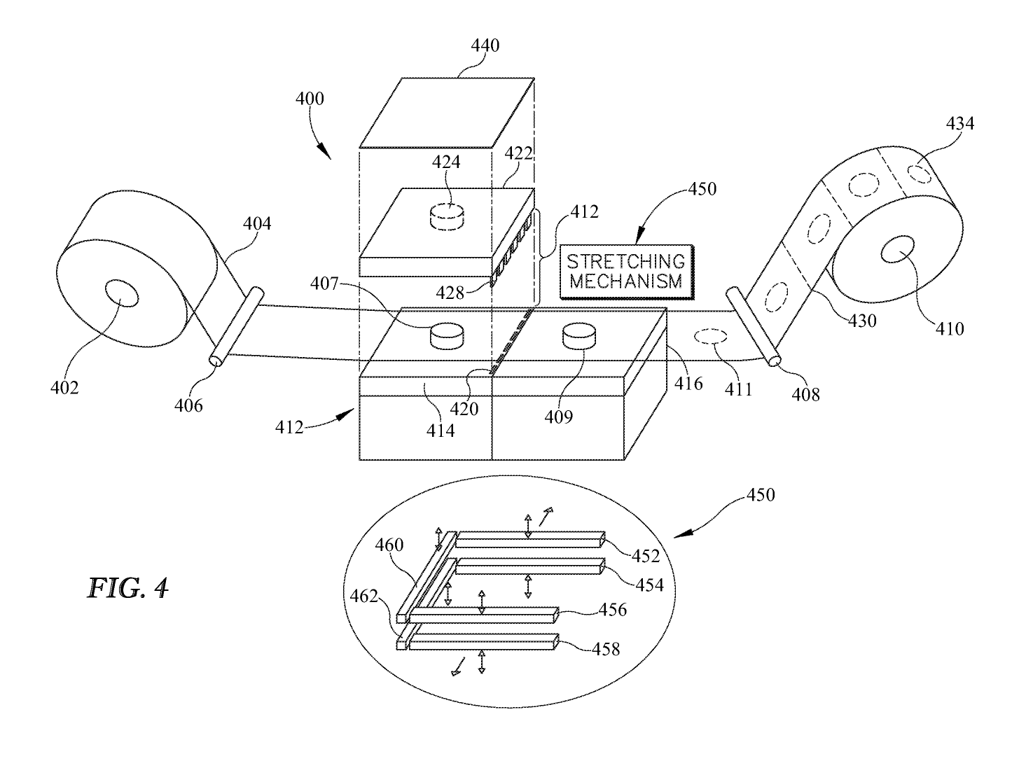

An illustrative application of this disclosure may be in sous vide cooking. The food product mentioned above in FIG. 3 is packaged into package 320 under vacuum with a shape memory polymer preprogrammed with a shape using the shaping temperature and having an appropriate trigger temperature at a cooking temperature. When the package 320 of food product or meat is placed into the sous vide water bath, the trigger temperature triggers the shape change of package 320 into the illustrative shape 340 depicted in FIG. 4. The product thus assumes the trained or memorized shape while cooking takes place. In these and other applications, the temperature effect of the trigger temperature may be transient, since the recovery or transition time for most materials is in the range of seconds to minutes which may not be so long as to significantly affect the meat. For example, in many instances, the elevated trigger temperature needed to trigger a transition to the memorized shape needs to be applied only transiently to the product. The transient exposure to elevated temperature does not much affect the core temperature of the meat or other product if only applied externally for a brief period.

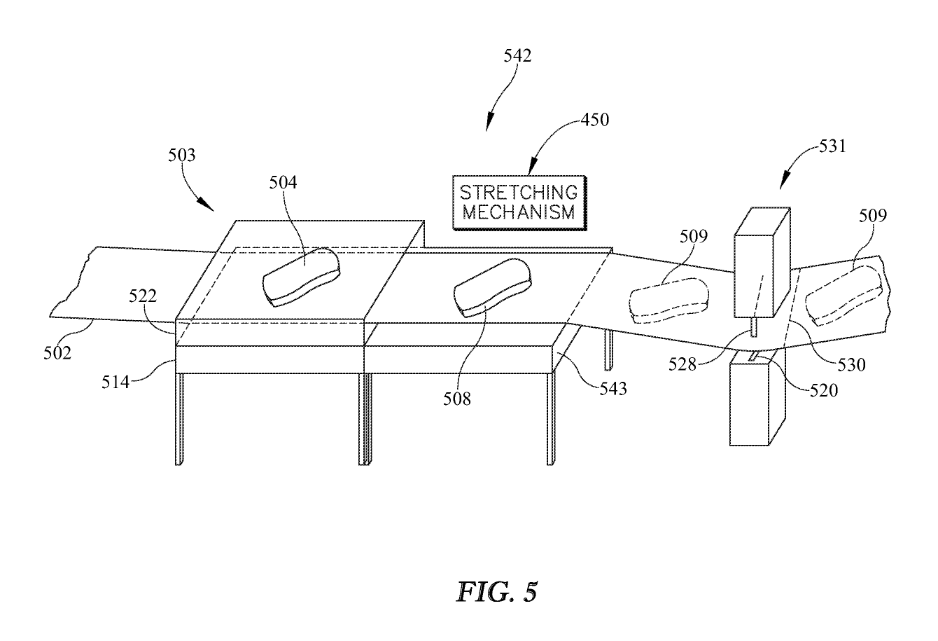

There are a variety of methods that may be used to train shape memory polymers for use in packaging and shaping meat products and other foods. Exemplary embodiments are disclosed in FIGS. 4 and 5, which depict, respectively, thermal transition training and training via a specific wavelength of light.

In FIG. 4, an exemplary process 400 for training shape memory polymers via a thermal transition is depicted. An unwind roll 402 of shape memory polymer 404 is unwound to begin the process. Roll 404 passes through rollers 406, 408 on its way to a take-up reel 410. One or both of unwind roll 404 and take-up reel 410 are powered.

Training takes place in oven 440 via a thermoforming tool 412 which includes a lower section 414 and an upper section 422, the lower section including a positive mold portion 407 in the desired shape of the food product and the upper section including a negative mold portion 424. The oven is heated to the shaping temperature to perform the training of the material to the desired shape 409. The tool 412 may also be equipped with a perforator 420, 428, shown with male and female portions, for placing perforations 430 as shown on the roll 404, forming a product roll 434 of perforated, trained shape memory polymer material with shapes 411. Perforations make it easier to separate individual sheets 432 later for use.

Stretching takes place on tool 416 via a stretching tool 450. As depicted in the exploded view of stretching tool 450, stretching tool 450 includes opposing plates 452, 454 and 456, 458, and 460, 462. The opposing plates clamp and unclamp the edges of the roll while the sheet is on tool 416 during the stretching operation. Opposing plates 452, 454 and 456, 458 also impart an outward stretching motion through mechanisms known in the art but not shown to perform the stretching motion. Stretching in the direction of the may be accomplished by advancement of take-up roll 410 while opposing plates 460, 462 hold the sheet in place. Once the stretching is completed the opposing plates unclamp the edges, allowing the roll to advance to pick-up roll 410. The temperature for the stretching is below the transition temperature as previously explained. This allows the material to be stretched into a flat sheet of material while retaining the memorized shape.

In operation, the thermoforming tool 412 is opened and the shape memory polymer 404 is advanced one-sheet-length at a time. The tool is closed, causing negative mold 424 to stretch fit the shape memory polymer about positive mold portion 416. The positive mold portion 416 provides the programmed shape to the shape memory polymer and so by using different shapes for positive mold portion 416, the shape memory polymer may be programmed with different shapes. Of course, the negative mold portion 424 is illustrative configured to be the negative of the positive mold portion 416 so as to facilitate contouring of the shape memory polymer about the positive mold portion during the programming process. The heat at the shaping temperature is applied by the furnace for a length of time sufficient for the memory to be impressed on the shape memory polymer. When the tool closes, perforation tool 420, 428 also closes, forming perforations for later use in separating individual sheets of shape memory polymer product.

The shaped, perforated deformed programmed sheet is then advanced to tool 416 where after cooling below the transition temperature of the shape memory material the sheet is stretched back into a flat form factor using stretching tool 450 as previously explained. Element 408 shows the shape of the programmed shape during stretching and element 409 shows the shape of the programmed shape after stretching, namely, in a flattened shape. The flat form factor lends the sheet to easier storage, shipping, and ultimate use as previously explained.

The shaped, perforated stretched, programmed sheet is then spooled about take-up reel 410.

In use, product roll 434 may be positioned in a food service preparation area. Alternatively, individual sheets 432 may be separated and placed in packages for use or sale, individual sheets being easier to use than a roll of hundreds or thousands of sheets. The food service preparation area may be in a meat department of a retail grocery store, in a packaging area of an abattoir, in a kitchen of a restaurant or catering firm, or other suitable application. When a meat product is produced, the product is wrapped in a sheet of shape memory polymer packaging material, as described above.

The trigger temperature of the shape memory polymer packaging material is selected according to the application or intended use of the packaged meat product, or other packaged food product. The packaging may be intended for retail presentation of the product, where the product will be in a refrigerated case, likely at a temperature from 3° C. to 4° C. or 38 to 40° F. This may be the desired transition temperature for the shape memory polymer.

Most of the above discussions on shape memory polymers have focused on heat-sensitive materials. Other shape memory polymer systems may be triggered by stimuli besides temperature. These may be useful for applications where it is not desirable to use heat. For example, light-activated shape memory polymers use photo-crosslinking and photo-cleaving to change the transition temperature. Photo-crosslinking is achieved using one wavelength of light, and a second wavelength of light later is used to reversibly cleave the photo-crosslinked bonds. In one example, polymers using cinnamic groups can be fixed into predetermined shapes by UV illumination, e.g., light with a wavelength greater than 260 nm. The memory shape is than triggered by exposure to UV at a different wavelength, e.g., light having a wavelength less than 260 nm. See Light-activated shape memory polymers and associated applications, E. Havens et al., Proc. SPIE 5762: 48 (2005).

The effect achieved is that the material may be reversibly switched between an elastomer and a relatively rigid polymer. It is light alone that achieves the change, not heat, in this example. The light does not change the temperature but it does change the crosslinking density of the material. An application for light-sensitive polymers is now discussed.

FIG. 5 depicts a process 500 for training a shape memory polymer, in roll form 502 using a light training processing tool 503. The process may include unwind and take-up reels, as shown in FIG. 4. In this illustrative example, tool 503 includes top 522 and bottom 514 sections with positive and negative mold portions as in FIG. 4 and in the desired shape of the food product. The top section 522 is configured as a platen with light sources so that when top and bottom sections come together to stretch the memory polymer to the shape of the mold, the light sources can be turned on to program this shape into the memory polymer. The process 500 also includes a perforator 531, with upper 530 and lower 520 halves for cutting perforations 530 into the processed shape memory polymer film.

The film is advanced one-sheet-length at a time and the light training processing tool 503 closes, the memory is set. The shaped, perforated deformed programmed sheet is then advanced to stretch machine 542 where the sheet is stretched back into a flat form factor using stretching tool 450 as previously explained. Element 508 shows the shape of the programmed shape during stretching and element 509 shows the shape of the programmed shape after stretching, namely, in a flattened shape. The flat form factor lends the sheet to easier storage, shipping, and ultimate use as previously explained. The processed film is then wound up for sale or for use later. Alternatively, the sheets may be separated at that point and packaged for sale or use. In the processing, the tool 510 is opened and the roll 530 is advanced one sheet length at a time. The tool is closed and the shape memory polymer 502 is stretched about the positive and negative mold portions of the tool in the desired shape. In this example, heat is not used, but rather light. The light sources are then turned on for a length of time sufficient to induce cross-linking the shape memory polymer in the desired shape. The tool is configured as a platen with light sources so that when top and bottom sections come together to stretch the memory polymer to the shape of the mold, the light sources can be turned on to program this shape into the memory polymer. When the tool is closed, perforator 531 cuts perforations 530 across the process roll with a plurality of perforating teeth or uses another convenient method to place perforations. The sheet is then stretched and then spooled onto a take-up reel (not shown).

### EXAMPLE 1

In a first example, a 1 mm film made of polyethylene terephthalate (PET)-polyethyleneoxide (PEO) block copolymer, crosslinked with 1.5% maleic anhydride is cut into 30 cm by 15 cm sheets. A stainless steel mold is heated to 90° C., before the sheet is placed into the mold. The mold is in the shape of a rib eye steak, about 3 cm thick and in a general shape of a parallelogram with rounded corners and having a short end of about 5 cm, a long end of about 10 cm, and an overall length between the ends of 15 cm. The film is then heated to a shaping temperature of 90° C. over the set shape of the mold for 2 minutes, and cooled to 4° Celsius in a chiller before being removed from the mold. The film is then stretched at 4° Celsius, which is an illustrative stretching temperature in this example, flat to 60 cm by 30 cm and allowed to cool to ambient temperature. In an illustrative example of use, this film is then used to shape a rib eye steak that has been hot boned from a chuck portion or forequarter of a steer. “Hot boning” of meat, separating cuts of meat before the onset of rigor mortis, causes the meat to sit flatter than the shape to which consumers are accustomed. A particular cut, such as this rib eye steak, then spreads out wider and thinner when placed on a rigid polyurethane tray for display in a retail meat counter or food service establishment. In this example the shape memory film at room temperature is now used to wrap a rib eye cut of meat that has been hot boned as soon as the meat is removed from the animal. The heat from the meat raises the film temperature to the transition point (i.e., trigger temperature), in this example between 8-13° C. The transition of the film to its shaped memory, molded in the classic shape of a rib eye steak, is achieved within one minute. The edges of the film are then heat sealed around the edges with standard heat sealing equipment to seal the steak in place to the polyurethane tray. The meat is then chilled down to 4° C. (38-40 degrees F.) in the chiller until distribution.

### EXAMPLE 2

In a second example, five kilograms of chuck steak are obtained in a form of small chunks of meat, each chunk less than one cubic centimeter (cc). The five kilograms of small chunks are then combined into a mixing bowl with 100 mg papain and 50 mg trypsin and mixed for 5 minutes for enzymatic tenderization. The enzymatic tenderization is then stopped by the mixing in 1 gm of citric acid. Ten (10) mg of red food coloring is then added and mixed into the meat. 250 g of rendered beef fat is then mixed through the mixture, together with 500 mg of transglutaminase.

A tube of polyurethane based shape memory polymer, 2 mm thick, is extruded into a shape of a hollow cylinder 15 cm in diameter. The polymer is cured such that the transition temperature (i.e., trigger temperature) is 40° C. The polymer is stretched to 16 cm over a steel mold which has 15.8 cm diameter indented rings every 3 cm, the rings about 2 mm thick. The mold is 1 m in length, and used to make 1 m long tubes of shape memory polymer tubing. This is accomplished by heating the mold with the film in place to 90° C. for 2 minutes, then cooling it to room temperature before removing the tube and stretching it at room temperature to 20 cm diameter. The tube is then filled with the meat mixture, vacuum sealed, and placed in cold storage until cooking. When cooking the meat, the 1 m tube is then place in a sous vide bath at 60 degrees for 48 hours. The temperature rise causes the tube to form a 16 cm tube with rings every 3 cm that are 2 mm thick and 2 mm deep. These indicate the cut marks for the chef, who then cuts the tube into 30 cuts resembling rib eye steak. These may be finished by flash grilling each steak for 30 seconds on each side over a flame broiler to brown them. This improves the appearance of the product before presentation to diners.

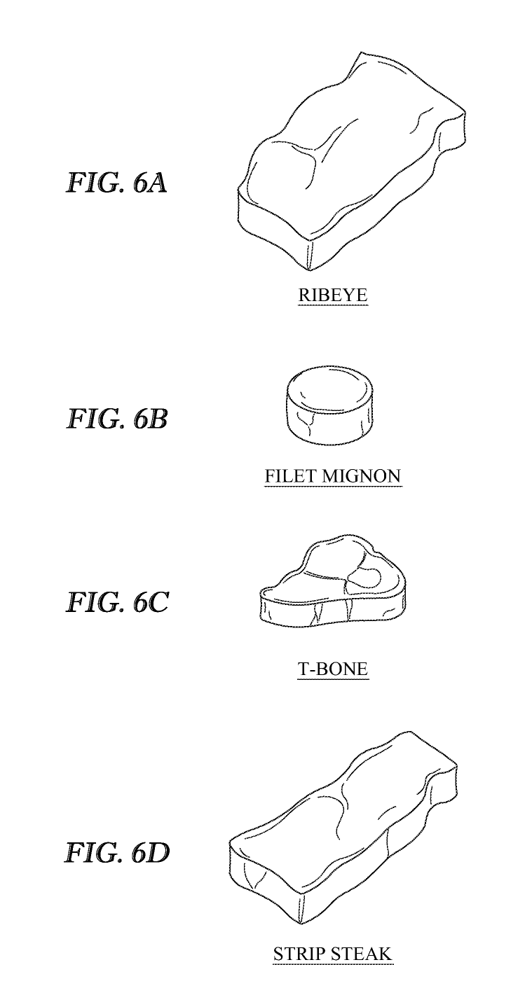

The above examples are illustrative of only a few ways to use the present disclosure. FIGS. 6A-6D, for example, depict desirable, relatively high-value shapes of meat that may benefit from shape memory polymer packaging of this disclosure. FIG. 6A illustrates the classic rib eye steak form discussed above. Beef tenderloin or filet mignon is associated with the right cylindrical shape depicted in FIG. 6B. A T-bone steak has the general form depicted in FIG. 6C. A strip steak or New York steak, generally a T-bone without the bone and the segment of tenderloin, is depicted in FIG. 6D. Each of these shapes is associated with high value and is not complicated in terms of a mold or a tool that would be required to achieve these shapes.

Other food items may also be shaped using shape memory polymers. For example, mashed potatoes and other vegetables may be formed into a variety of interesting shapes, such as geometrical shapes, the suits of playing cards, and the like. Illustrative examples may include stars, spades, hearts, diamonds, clubs, rectangles, squares, parallelograms, cylinders and the like. Relishes, sauces, garnishes, compotes, petit-fours and similar food items may also be shaped using shape memory polymers as discussed herein.

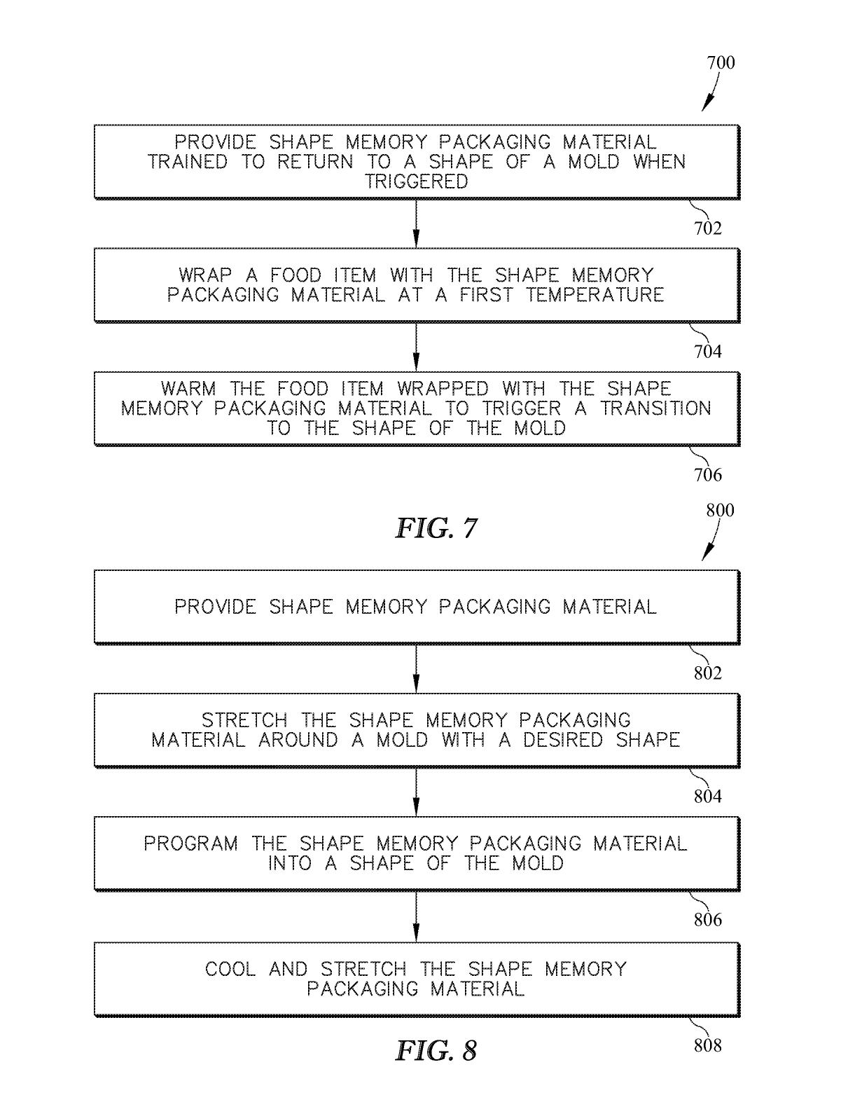

Methods of practicing the present disclosure are presented in FIGS. 7 and 8. In FIG. 7, a method 700 include a first step 702 of providing shape memory packaging material that has been trained to return to a shape of a mold when triggered. A food item, such as a cut of raw meat, is then wrapped 704 with the shape memory packaging material at a first temperature. The food item that has been wrapped with the shape memory packaging material is then warmed or otherwise triggered 706 to transition to the shape of the mold. The trigger may be by warming the food item, or as discussed above, may be triggered by refrigerating the food item. If the shape memory packaging material was shaped by exposure to light, then re-exposure to light will re-trigger the transition to the trained and desired shape.

Another method 800 of practicing the present disclosure is presented in FIG. 8. In this method, shape memory packaging material is provided 802 in a first step. The shape memory packaging material is then stretched 804 around a mold with a desired shape. As discussed above, the shape may be one that is associated with a desirable food item, such as a particular shape of a cut of meat. The shape memory packaging material is then programmed 806 into a shape of the mold. After the material has cooled, it is stretched 808 into a flat shape. As discussed, the programming may be accomplished by heating the mold or a tool containing the mold to a transition temperature that is desired. Programming may also be achieved by using light-sensitive shape memory polymers and exposing them to radiation, e.g., certain wavelengths of light that will cause the polymers to cross-link and achieve the shape of the mold. After shaping and cooling, the shape memory packaging materials, such as sheets, are then stretched as desired, e.g., into a flat shape.

The process is described above primarily for cuts of beef, which comprise a high volume in both a physical sense and in their value in commerce. Other meats may also be processed using the techniques discussed above, such as pork, veal, lamb, goatmeat, and the like.

There are many embodiments of the present disclosure. It is clear from the above that shape memory polymers are useful in aiding the appearance of a meat product and even in assisting in preparation of the meat product for cooking and serving. The packaging systems described here provide a relatively low cost strategy to improve the value of the meat product by producing optimal shapes and sizes. At least one advantage over present-day packaging is in the responsiveness and control which is provided over the final shape of the product. This can be useful for presentation to end consumers, as well as in food service applications where size and shape are important for portion uniformity as well as appearance.

In view of this disclosure, it will be seen that technologies are generally described for shape memory meat packaging. As noted, the technique is advantageously used on cuts of meat to improve their appearance or to aid in portion control. While advantageous, cost may also be a consideration in the use of this technology. Packages design in view of this disclosure may integrate shape memory polymers with less expensive plastics. For example, film overwrap may include a base layer of polyethylene or polypropylene with an added layer of shape memory polymer to provide a shaping effect on the meat. In another embodiment, the shape memory polymer may be used laminated to another, less expensive film, providing for the shaping actuation while minimizing the amount of shape memory polymer needed. These effects may be achieved by preparing the shape memory polymer product as shown in FIGS. 4-5, but without perforating, if desired. The finished roll of shape memory polymer may then be combined with a layer of less expensive packaging material, using known techniques, and the combination film perforated while rewind takes place.

Most of the above discussions on shape memory polymers have focused on heat-sensitive materials. Other shape memory polymer systems are well-known, such as the light-activated shape memory polymers discussed with respect to FIG. 5. There are still other shape memory polymers, using other techniques and materials. For example, some shape memory polymer systems use additives such as carbon nanotubes, short carbon fibers, carbon black and metallic nickel power. These materials achieve a shape memory effect by the application of a voltage or a current to a conductive shape memory polymer. It is also possible train these materials to a particular shape by the application of an electromagnetic material. Not all of these materials will be suitable for direct contact with food products and some may be too expensive today for use in these applications.

There are many advantages to the disclosed apparatuses and methods, including improved appearance of meat products and other food items. Techniques and technologies are generally described herein for providing shape memory polymer packaging for meat products from sheets or films of shape memory polymer material. Shape memory polymers are a class of smart materials which have the ability to return to their original or trained state from a deformed or temporary state when a stimulus is provided. The stimulus is typically a temperature change. The stimulus may also be exposure to an electric or magnetic field, exposure to light, or even exposure to a particular atmosphere, e.g., water. Shape memory polymers now include many materials, including both thermoplastic materials and thermoset materials (covalently cross-linked). The memory effect of the shape memory polymer is used to shape a meat product and to make the meat product more attractive to a consumer.

One embodiment of the disclosure is a method for shaping a food item. The method includes a step of providing a shape memory packaging material configured to transition to a shape of a mold when a transition parameter of the shape memory packaging material is triggered. The method includes steps of stretching the shape memory packaging material around a mold of a desired shape, programming the shape memory packaging material to take the shape of the mold and then stretching the material into a temporary shape. The method also includes wrapping a food item with the shape memory packaging material and then triggering the transition parameter to cause the shape memory packaging material to take the shape of the mold.

Another embodiment further includes steps of providing a shape memory packaging material, stretching the shape memory packaging material around a mold of a desired shape and programming the shape memory packaging material to take the shape of the mold. In a further embodiment, the transition parameter is a transition temperature of a shape memory packaging material and the shape memory packaging material is programmed by warming the mold and the shape memory packaging material to a shaping temperature of the shape memory packaging material and subsequently cooling the shape memory packaging material below the transition trigger temperature and then stretching the shape memory packaging material into a temporary shape at a stretching temperature.

In embodiments, the transition parameter is selected from the group consisting of temperature, wavelength, and electromagnetic radiation. In embodiments, the shape memory packaging material includes a composite material having a first thickness of a shape memory packaging material laminated to a second thickness of a base material. In some embodiments, the shape memory packaging material is a thermoplastic material. In some embodiments, the shape memory packaging material is a linear block copolymer. In some embodiments, the shape memory packaging material is selected from the group consisting of a polyurethane, a polyurethane with an ionic component, a polyurethane with a mesogenic component, a polyethylene terephthalate block copolymer, a polyethyleneoxide copolymer, a block copolymer comprising polystyrene and poly (1,4-butadiene, an ABA triblock copolymer and an ABA triblock copolymer comprising poly-tetrahydrofuran and poly (2-methyl-2-oxazoline).

In some embodiments, the shape memory packaging material is a thermoset material. In some embodiments, the shape memory packaging material is selected from the group consisting of amorphous polynorbornene and polynorbornene in which at least one polynorbornene unit is substituted by polyhedral oligosilsesquioxane (POSS). In embodiments, the food item is selected from the group consisting of a meat item and a vegetable item.

Another embodiment is a method for shaping a food product. The method includes steps of providing a shape memory packaging material configured to return to a shape of a mold when a transition parameter of the shape memory packaging material is triggered. The method also includes wrapping a food item with the shape memory packaging material and triggering the shape memory packaging material to transition the shape memory packaging material to the shape of the mold and form the food item into the shape of the mold.

In another embodiment, the sheet of shape memory packaging material is configured to take the shape of a mold by stretching the shape memory packaging material around the mold, heating the shape memory packaging material to a shaping temperature, and then returning the shape memory packaging material to a temperature below the transition trigger temperature; stretching the shape memory material to a temporary shape while cooled; and wherein triggering is accomplished by warming the food item to the transition trigger temperature. In embodiments, the food item comprises a freshly-slaughtered meat item whose temperature triggers the shape memory packaging material upon wrapping.

In some embodiments, the memory of the shape memory packaging material is triggered by heating the wrapped food item at a sous vide cooking temperature from 55-90° C. In some embodiments, the method further includes steps of providing a shape memory packaging material, stretching the shape memory packaging material around the mold, configuring the shape memory packaging material into a shape of the mold and deforming the shape memory packaging material into a temporary shape.

In embodiments, the step of configuring is accomplished by warming the shape memory packaging material into the shape of the mold above a transition temperature and then allowing the shape memory packaging material to cool below the transition temperature while remaining around the mold. In other embodiments, the step of configuring is accomplished by illuminating the shape memory packaging material with light at a first wavelength to configure the shape memory packaging material to memorize the shape of the mold by increasing a cross-link density of the shape memory packaging material.

In yet other embodiments, the step of triggering is accomplished by exposing the shape memory packaging material to a second wavelength to decrease the cross-link density of the shape memory packaging material into the shape of the mold. In yet other embodiments, the step of configuring is accomplished by applying a first voltage or current of electricity to the shape memory packaging material to configure the material to memorize the shape of the mold. In embodiments, the step of triggering is accomplished by applying a second voltage or current of electricity to the shape memory packaging material into the shape of the mold.

In other embodiments, a package for shaping a food item is prepared by a process comprising the steps of: providing a shape memory packaging material configured to transition to a shape of a mold when a transition parameter of the shape memory packaging material is triggered; wrapping a food item with the shape memory packaging material; triggering the transition parameter to cause the shape memory packaging material to take the shape of the mold; and separating the shape memory packaging material from the mold. The shape memory packaging material may be configured to transition to a shape of a mold is formed by providing a shape memory packaging material; stretching the shape memory packaging material around a mold of a desired shape; and programming the shape memory packaging material to take the shape of the mold. The transition parameter may be a transition temperature of a shape memory packaging material and the shape memory packaging material is programmed by warming the mold and the shape memory packaging material above a transition temperature of the shape memory packaging material and subsequently cooling the shape memory packaging material below the transition temperature while the shape memory packaging material remains in the desired shape. The transition parameter may be selected from the group consisting of temperature, wavelength, and electromagnetic radiation.

The present disclosure is not to be limited in terms of the particular embodiments described in this application, which are intended as illustrations of various aspects. Many modifications and variations can be made without departing from its spirit and scope, as will be apparent to those skilled in the art. Functionally equivalent methods and apparatuses within the scope of the disclosure, in addition to those enumerated herein, will be apparent to those skilled in the art from the foregoing descriptions. Such modifications and variations are intended to fall within the scope of the appended claims. The present disclosure is to be limited only by the terms of the appended claims, along with the full scope of equivalents to which such claims are entitled. It is to be understood that this disclosure is not limited to particular methods, reagents, compounds compositions or biological systems, which can, of course, vary. It is also to be understood that the terminology used herein is for the purpose of describing particular embodiments only, and is not intended to be limiting.

With respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to embodiments containing only one such recitation, even when the same claim includes the introductory phrases “one or more” or “at least one” and indefinite articles such as “a” or “an” (e.g., “a” and/or “an” should be interpreted to mean “at least one” or “one or more”); the same holds true for the use of definite articles used to introduce claim recitations. In addition, even if a specific number of an introduced claim recitation is explicitly recited, those skilled in the art will recognize that such recitation should be interpreted to mean at least the recited number (e.g., the bare recitation of “two recitations,” without other modifiers, means at least two recitations, or two or more recitations). Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). In those instances where a convention analogous to “at least one of A, B, or C, etc.” is used, in general such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, etc.). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

In addition, where features or aspects of the disclosure are described in terms of Markush groups, those skilled in the art will recognize that the disclosure is also thereby described in terms of any individual member or subgroup of members of the Markush group.

As will be understood by one skilled in the art, for any and all purposes, such as in terms of providing a written description, all ranges disclosed herein also encompass any and all possible subranges and combinations of subranges thereof. Any listed range can be easily recognized as sufficiently describing and enabling the same range being broken down into at least equal halves, thirds, quarters, fifths, tenths, etc. As a non-limiting example, each range discussed herein can be readily broken down into a lower third, middle third and upper third, etc. As will also be understood by one skilled in the art all language such as “up to,” “at least,” “greater than,” “less than,” and the like include the number recited and refer to ranges which can be subsequently broken down into subranges as discussed above. Finally, as will be understood by one skilled in the art, a range includes each individual member. Thus, for example, a group having 1-3 cells refers to groups having 1, 2, or 3 cells. Similarly, a group having 1-5 cells refers to groups having 1, 2, 3, 4, or 5 cells, and so forth.

While various aspects and embodiments have been disclosed herein, other aspects and embodiments will be apparent to those skilled in the art. The various aspects and embodiments disclosed herein are for purposes of illustration and are not intended to be limiting, with the true scope and spirit being indicated by the following claims.

What is claimed is:

1. A method for shaping a food item, the method comprising:
providing a shape memory packaging material;
stretching the shape memory packaging material around a mold of a desired shape;
programming the shape memory packaging material to take the shape of the mold; and
stretching the programmed material into a temporary shape.

2. The method of claim 1, further comprising:
wrapping a food item with the programmed shape memory packaging material; and
triggering a transition parameter of the shape memory packaging material to cause the shape memory packaging material to take the shape of the mold.

3. The method of claim 2, wherein the transition parameter is a transition trigger temperature of the shape memory packaging material and the shape memory packaging material is programmed by: (i) warming the mold and the shape memory packaging material to a shaping temperature of the shape memory packaging material, (ii) cooling the shape memory packaging material below a trigger temperature of the shape packaging material; and (iii) stretching the shape memory packaging material into the temporary shape.

4. The method of claim 2, wherein the programing and the transition trigger parameter is selected from the group consisting of temperature, wavelength, and electromagnetic radiation

5. The method of claim 1, wherein the shape memory packaging material comprises a composite material having a first thickness of a shape memory packaging material laminated to a second thickness of a base material.

6. The method of claim 1, wherein the shape memory packaging material is a thermoplastic material.

7. The method of claim 1, wherein the shape memory packaging material is a linear block copolymer.

8. The method of claim 1, wherein the shape memory packaging material is selected from the group consisting of a polyurethane, a polyurethane with an ionic component, a polyurethane with a mesogenic component, a polyethylene terephthalate block copolymer, a polyethyleneoxide copolymer, a block copolymer comprising polystyrene and poly (1,4-butadiene, an ABA triblock copolymer and an ABA triblock copolymer comprising poly-tetrahydrofuran and poly (2-methyl-2-oxazoline).

9. The method of claim 1, wherein the shape memory packaging material is a thermoset material.

10. The method of claim 1, wherein the shape memory packaging material is selected from the group consisting of amorphous polynorbornene and polynorbornene in which at least one polynorbornene unit is substituted by polyhedral oligosilsesquioxane (POSS).

11. The method of claim 1, wherein the food item is selected from the group consisting of a meat item and a vegetable item.

12. A method for shaping a food item, the method comprising:
providing a shape memory packaging material configured to return to a shape of a mold when a transition parameter of the shape memory packaging material is triggered;
wrapping a food item with the shape memory packaging material; and
triggering the shape memory packaging material to transition the shape memory packaging material to the shape of the mold and form the food item into the shape of the mold.

13. The method of claim 12, wherein the shape memory packaging material is configured to take the shape of a mold by: (i) warming the mold and the shape memory packaging material to a shaping temperature of the shape memory packaging material, (ii) cooling the shape memory packaging material below a trigger temperature of the shape packaging material; and (iii) stretching the shape memory packaging material into a temporary shape.

14. The method of claim 12, wherein the food item comprises a freshly-slaughtered meat item whose temperature triggers the shape memory packaging material upon wrapping.

15. The method of claim 12, wherein the memory of the shape memory packaging material is triggered by heating the wrapped food item at a sous vide cooking temperature from 55-90° C.

16. The method of claim 12, wherein the shape memory packaging material configured to transition to a shape of a mold is formed by:
providing a shape memory packaging material;
stretching the shape memory packaging material around the mold;
configuring the shape memory packaging material into a shape of the mold; and
stretching the configured shape memory packaging material into a temporary shape.

17. The method of claim 16, wherein the step of configuring is accomplished by warming the shape memory packaging material into the shape of the mold above a shaping temperature and then allowing the shape memory packaging material to cool below the triggering temperature while remaining around the mold.

18. The method of claim 16, wherein the step of configuring is accomplished by illuminating the shape memory packaging material with light at a first wavelength to configure the shape memory packaging material to memorize the shape of the mold by increasing a cross-link density of the shape memory packaging material.

19. The method of claim 18, wherein the step of triggering is accomplished by exposing the shape memory packaging material to a second wavelength to decrease the cross-link density of the shape memory packaging material into the shape of the mold.

20. The method of claim 16, wherein the step of configuring is accomplished by applying a first voltage or current of electricity to the shape memory packaging material to configure the material to memorize the shape of the mold.

21. The method of claim 20, wherein the step of triggering is accomplished by applying a second voltage or current of electricity to the shape memory packaging material into the shape of the mold.

22. A package for shaping a food item prepared by a process comprising the steps of:
providing a shape memory packaging material configured to transition to a shape of a mold when a transition parameter of the shape memory packaging material is triggered;
wrapping a food item with the shape memory packaging material;
triggering the transition parameter to cause the shape memory packaging material to take the shape of the mold; and
separating the shape memory packaging material from the mold.

23. The package of claim 22 wherein the shape memory packaging material configured to transition to a shape of a mold is formed by:
providing a shape memory packaging material;
stretching the shape memory packaging material around a mold of a desired shape; and
programming the shape memory packaging material to take the shape of the mold.

24. The package of claim 23, wherein the transition parameter is a transition trigger temperature of a shape memory packaging material and the shape memory packaging material is programmed by(i) warming the mold and the shape memory packaging material to a shaping temperature of the shape memory packaging material, (ii) cooling the shape memory packaging material below a trigger temperature of the shape packaging material; and (iii) stretching the shape memory packaging material into a temporary shape.

25. The package of claim 23, wherein the transition parameter is selected from the group consisting of temperature, wavelength, and electromagnetic radiation.
